(19) United States
(12) Patent Application Publication
(10) Pub. No.: US 2023/0317938 A1
(43) Pub. Date: Oct. 5, 2023

(54) METHOD FOR MANUFACTURING POSITIVE ELECTRODE MATERIAL

(71) Applicant: HONDA MOTOR CO., LTD., Tokyo (JP)

(72) Inventors: Yui KINOSHITA, Saitama (JP); Keiko MORI, Saitama (JP); Satoshi AOKI, Saitama (JP); Rio KOYAMA, Saitama (JP); Makoto TANAKA, Saitama (JP)

(73) Assignee: HONDA MOTOR CO., LTD., Tokyo (JP)

(21) Appl. No.: 18/126,044

(22) Filed: Mar. 24, 2023

(30) Foreign Application Priority Data
Mar. 31, 2022 (JP) 2022-059160

(51) Int. Cl. H01M 4/505; H01M 4/525; H01M 4/62; H01M 10/0562

(52) U.S. Cl. CPC H01M 4/505; H01M 4/525; H01M 4/625; H01M 10/0562; H01M 2300/008; H01M 2300/0068; H01M 2300/0071; H01M 2004/028

(57) ABSTRACT

A method for manufacturing a positive electrode material of a solid-state battery, the method includes a first mixing to mix a positive electrode active material with a conductive aid to generate a first powder, a second mixing to mix a solid electrolyte with the conductive aid to generate a second powder, and a third mixing to mix the first powder with the second powder to generate a third powder. According to the method, it is possible to reduce the amount of a dispersion medium when generating a slurry in manufacturing the positive electrode material.

### CROSS-REFERENCE TO RELATED APPLICATIONS

The present application claims the benefit of priority of Japanese Patent Application No. 2022-059160, filed on Mar. 31, 2022, the content of which is incorporated herein by reference.

### TECHNICAL FIELD

The present invention relates to a method for manufacturing a positive electrode material.

### BACKGROUND ART

In recent years, researches and development on secondary batteries that contribute to energy efficiency have been carried out to ensure access to convenient, reliable, sustainable, and advanced energy for more people.

As a secondary battery, a lithium ion secondary battery is widely used. A lithium ion secondary battery using a liquid as an electrolyte has a structure in which a separator is present between a positive electrode and a negative electrode and filled with a liquid electrolyte (electrolytic solution).

Since the electrolytic solution of the lithium ion secondary battery is usually a combustible organic solvent, there have been cases where the safety against heat has become a problem. Therefore, a solid-state battery using a flame-retardant solid electrolyte instead of the organic liquid electrolyte has also been proposed.

A solid-state secondary battery includes an inorganic solid electrolyte, an organic solid electrolyte, or a gel-like solid electrolyte as an electrolyte layer between a positive electrode and a negative electrode. In a solid-state battery using a solid electrolyte, as compared with a battery using an electrolytic solution, the problem caused by heat can be solved, the capacity can be increased and/or the voltage can be increased, and the demand for compactness can also be met.

A positive electrode material of such a lithium ion secondary battery is prepared by mixing a positive electrode active material, a conductive aid, and a solid electrolyte, further mixing a dispersion medium to form a slurry, coating a current collector with the slurry, and performing drying (for example, JP2015-76387A). Note that in the present disclosure, the dispersion medium means a solvent containing a binder.

### SUMMARY OF INVENTION

Here, in the step of generating the slurry, it is preferable that an amount of the dispersion medium is small. When the necessary amount of the dispersion medium is reduced, the manufacturing cost can be reduced and the manufacturing time can be shortened. As a result of intensive examination of the present inventor, it has been found that in order to reduce the necessary amount of the dispersion medium, it is necessary to reduce a total surface area of all materials by compositing the positive electrode active material, the conductive aid, and the solid electrolyte, and therefore, it is necessary to form particles in an appropriate dispersed state at the raw material stage.

The present embodiment provides a method for manufacturing a positive electrode material, which can reduce an amount of a dispersion medium when generating a slurry. The present embodiment contributes to improvement in energy efficiency.

The present embodiment provides a method for manufacturing a positive electrode material of a solid-state battery, the method including:
a first mixing step of mixing a positive electrode active material with a conductive aid to generate a first powder;
a second mixing step of mixing a solid electrolyte with a conductive aid to generate a second powder; and
a third mixing step of mixing the first powder with the second powder to generate a third powder.

According to the present invention, it is possible to reduce the amount of the dispersion medium when generating the slurry in manufacturing the positive electrode material.

### BRIEF DESCRIPTION OF DRAWINGS

Exemplary embodiment(s) of the present invention will be described in detail based on the following figures, wherein:

FIG. 1 is a cross-sectional view of a solid-state battery 1;

FIG. 2 is a flow diagram schematically showing a method for manufacturing a positive electrode material;

FIG. 3 is a graph showing a relationship between a solid content and a HIS area;

FIG. 4 is a graph showing a relationship between the solid content and a viscosity; and

FIG. 5 is a schematic diagram showing a state of particles dispersed in a slurry.

### DESCRIPTION OF EMBODIMENTS

First, a solid-state battery using a positive electrode material according to the present invention will be described.

### [Solid-State Battery]

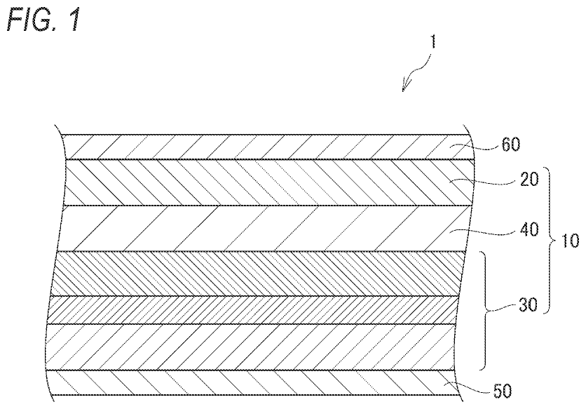

As shown in FIG. 1, a solid-state battery 1 includes a battery body 10, a negative electrode current collector 50, and a positive electrode current collector 60. Note that in the present description, the solid-state battery refers to a fully solid-state battery.

The negative electrode current collector 50 and the positive electrode current collector 60 are conductive plate-shaped members that sandwich the battery body 10 from both sides. The negative electrode current collector 50 has a function of collecting a current from a negative electrode layer 30, and the positive electrode current collector 60 has a function of collecting a current from a positive electrode layer 20. The battery body 10 includes the positive electrode layer 20 functioning as a positive electrode, the negative electrode layer 30 functioning as a negative electrode, and a conductive solid electrolyte layer 40 positioned between the positive electrode layer 20 and the negative electrode layer 30. The positive electrode layer 20 is manufactured by coating the positive electrode current collector 60 with a slurry containing a positive electrode active material as a positive electrode material, a conductive aid, and a solid electrolyte, and performing drying.

[Method for Manufacturing Positive Electrode Material]

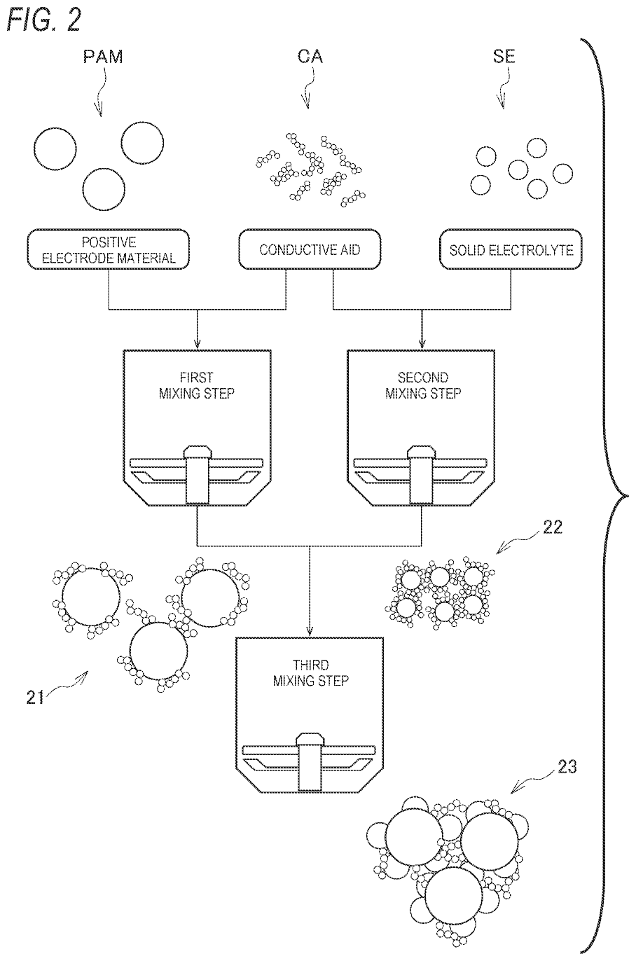

Hereinafter, a method for manufacturing a positive electrode material according to an embodiment of the present invention will be described with reference to FIG. 2.

The method for manufacturing a positive electrode material includes the following steps.
1. a first mixing step of mixing a positive electrode active material PAM with a conductive aid CA to generate a first powder 21
2. a second mixing step of mixing a solid electrolyte SE with the conductive aid CA to generate a second powder 22
3. a third mixing step of mixing the first powder 21 with the second powder 22 to generate a third powder 23
4. a slurry generating step of mixing the third powder 23 with a dispersion medium
5. a slurry coating step of coating a current collector with a slurry

The method for manufacturing a positive electrode material according to the present embodiment is different from a manufacturing method in the related art in which the positive electrode active material PAM, the solid electrolyte SE, and the conductive aid CA are mixed at once, and is characterized by separately performing mixing of the positive electrode active material PAM and the conductive aid CA, mixing of the solid electrolyte SE and the conductive aid CA, and further mixing the respective mixtures together. When the positive electrode active material PAM is excessively coated with the insulating solid electrolyte SE, an electron conduction path cannot be formed. However, by previously compositing the conductive aid CA on the surface of each of the positive electrode active material PAM and the solid electrolyte SE, both conduction paths for electrons and lithium ions (Li⁺) can be achieved. Insufficient compositing results in a large surface area of particles, resulting in a large amount of dispersion medium necessary for slurrying, while sufficient compositing can reduce the amount of the dispersion medium.

In order to properly exhibit the function of the positive electrode active material PAM, when the positive electrode active material PAM is coated with a coating material, it is necessary to crush the coating material without causing damage thereto. In order to properly exhibit the function of the solid electrolyte SE, it is necessary to take measures to prevent re-aggregation during crushing since the solid electrolyte SE tends to aggregate. In addition, in order to properly exhibit the function of the conductive aid CA, it is necessary to crush the conductive aid CA into a length that functions as an electron conduction path after drying.

Therefore, in the present embodiment, in the first mixing step, the positive electrode active material PAM and the conductive aid CA are mixed in a dry method, and in the second mixing step, the solid electrolyte SE and the conductive aid CA are mixed in a dry method. After the first mixing step and the second mixing step, the particles are composited with the positive electrode active material PAM and the solid electrolyte SE as mother particles and the conductive aid CA as child particles. Compositing means that the van der Waals force due to a difference in particle size acts between child particles having a small particle size and mother particles having a large particle size, which are obtained by crushing and dispersing aggregates of respective materials with a shear stress above a certain level, to form composite particles. Hereinafter, particles mixed through the first mixing step and the second mixing step may be referred to as composite particles.

In order to separate the mixing step, when the originally necessary amount of the conductive aid CA is set to 1, for example, ½ of the conductive aid CA is mixed with the positive electrode active material PAM in the first mixing step, and ½ of the conductive aid CA is mixed with the solid electrolyte SE in the second mixing step. When the mixing step is separated, it is possible to perform a dispersion treatment suitable for the respective materials described above. That is, when all materials are mixed under the same conditions, the functions of the materials cannot be guaranteed. However, when the mixing step is separated into the first mixing step and the second mixing step and the solid electrolyte SE and the positive electrode active material PAM are mixed under optimum conditions, it is possible to perform a dispersion treatment suitable for respective materials.

When the dispersed composite particles are properly mixed, the structure of the finally generated composite particles can be controlled. Accordingly, the amount of the dispersion medium is reduced, and the time necessary for the slurry generating step can be shortened. Note that the dry method means mixing without using a dispersion medium.

Hereinafter, respective steps will be described in detail.

[First Mixing Step]

In the first mixing step, the positive electrode active material PAM and the conductive aid CA are mixed in a dry method to generate the first powder 21.

Examples of the positive electrode active material PAM include oxides containing lithium and cobalt as constituent metal elements, and oxides containing at least one other metal element other than lithium and cobalt as constituent metal elements. Examples of the metal element other than lithium and cobalt include Ni, Mn, Al, Cr, Fe. V, Mg, Ca. Na, Ti, Zr, Nb, Mo, W, Cu, Zn, Ga, In, Sn, La, and Ce. These may be contained alone or in combination of two or more thereof.

Examples of the positive electrode active material PAM include LiCoO₂. In addition, examples thereof include a lithium nickel cobalt manganese-based oxide (NCM) represented by the following general formula (1). The NCM is preferred in term of a high energy density per volume and excellent thermal stability.

LiNiₐCo_{b}Mn_{c}O₂ (1)

(In the formula, 0<a<0<b<1, 0<c<1, and a+b+c=1.)

In addition, examples of the positive electrode active material PAM include a lithium nickel cobalt aluminum-based oxide (NCA) represented by the following general formula (2).

LiₜNi_{1-x-y}CoₓAl_{y}O₂ (2)

(In the formula, 0.95≤t≤1.15, 0≤x≤0.3, 0.1≤y≤0.2, and x+y<0.5.)

The surface of the positive electrode active material PAM is preferably coated in advance with an oxide-based solid electrolyte. When the surface of the positive electrode active material PAM is coated with an oxide-based solid electrolyte, the interfacial resistance between the positive electrode active material PAM and the oxide-based solid electrolyte in contact therewith can be reduced, and the ion conductivity can be improved.

Note that the coating with the oxide-based solid electrolyte is preferably in the form of a film without particle boundaries and coats the entire surface of the positive electrode active material. Accordingly, the particle boundary resistance of particles after coating can be reduced. Such a particle boundary-free film-like coating layer is formed by spray coating, for example.

Examples of the oxide-based solid electrolyte include LiNbO₃ in the case of a lithium ion battery. In addition, examples thereof include a NASICON type oxide, a garnet type oxide, and a perovskite type oxide. Examples of the NASICON type oxide include an oxide containing Li, Al, Ti, P, and O (such as Li_{1.5}Al_{0.5}Ti_{1.5}(PO₄)₃). Examples of the garnet type oxide include an oxide containing Li, La, Zr, and O (such as Li₇La₃Zr₂O₁₂). Examples of the perovskite type oxide include an oxide containing Li, La, Ti, and O (such as LiLaTiO₃).

The conductive aid CA is carbon, and examples thereof include acetylene black, carbon nanotubes, graphene, and graphite particles.

In the first mixing step, the positive electrode active material PAM and the conductive aid CA are dispersed, and the positive electrode active material PAM is wrapped with the conductive aid CA. Therefore, the positive electrode active material PAM and the conductive aid CA are intended to be gently loosened and sprinkled. Specifically, the stirring speed is set to a peripheral speed of 40 m/s to 80 m/s, and the stirring time is set to 30 minutes to 60 minutes. In addition, the temperature during stirring is preferably 150° C. or lower.

[Second Mixing Step]

In the second mixing step, the solid electrolyte SE and the conductive aid CA are mixed in a dry method to generate the second powder 22.

Examples of the solid electrolyte SE include a sulfide-based solid electrolyte. A sulfide-based solid electrolyte material usually contains a metal element (M) to be conductive ions and sulfur (S). Examples of the M include Li, Na, K, Mg, and Ca. Among these, Li is preferred. In particular, the sulfide-based solid electrolyte material preferably contains Li, A (A is at least one selected from the group consisting of P, Si, Ge. Al, and B), and S. The A is preferably P (phosphorus). Further, the sulfide-based solid electrolyte material may contain halogens such as Cl, Br, and I. This is because containing halogens improves the ion conductivity. In addition, the sulfide-based solid electrolyte material may contain O.

Examples of the sulfide-based solid electrolyte material having Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl. Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any one of Ge. Zn, and Ga), Li₂S—GeS₂, Li₂S—SiS₂—Li₃PO₄, and Li₂S—SiS₂—LiₓMO_{y} (where x and y are positive numbers, and M is any one of P, Si, Ge, B, Al, Ga, and In). Note that the description of “Li₂S—P₂S₅” means a sulfide-based solid electrolyte material formed using a raw material composition containing Li₂S and P₂S₅, and the same applies to other descriptions.

Note that the conductive aid CA is the same as the conductive aid CA described in the first mixing step, so that the description is omitted here.

In the second mixing step, the solid electrolyte SE and the conductive aid CA are dispersed, and the solid electrolyte SE is wrapped with the conductive aid CA. Therefore, the solid electrolyte SE and the conductive aid CA are intended to be firmly loosened and sprinkled. Specifically, the stirring speed is set to a peripheral speed of 40 m/s to 80 m/s, and the stirring time is set to 30 minutes to 60 minutes. In addition, the temperature during stirring is preferably 100° C. or lower.

[Third Mixing Step]

In the third mixing step, the first powder 21 (composite particles of the positive electrode active material PAM and the conductive aid CA) obtained in the first mixing step and the second powder 22 (composite particles of the solid electrolyte SE and the conductive aid CA) obtained in the second mixing step are mixed in a dry method to generate the third powder 23.

In the third mixing step, the first powder 21 and the second powder 22 are intended to be loosened and sprinkled in a short time. Specifically, the stirring speed is set to a peripheral speed of 0 m/s to 10 m/s, and the stirring time is set to 10 minutes to 30 minutes. In addition, the temperature during stirring is preferably 100° C. or lower.

Comparing the third mixing step with the first mixing step and the second mixing step, the stirring speed is preferably slower in the third mixing step than in the first mixing step and the second mixing step.

[Slurry Generating Step]

In the slurry generating step, the third powder 23 (composite particles of the positive electrode active material PAM, the solid electrolyte SE, and the conductive aid CA) and a dispersion medium are mixed.

The dispersion medium is not particularly limited, and examples thereof include organic solvents such as N-methyl-2-pyrrolidone (NMP), toluene, butyl butyrate, or alcohols, and water. Butyl butyrate is preferred.

In addition, the dispersion medium contains a binder. Examples of the binder include a styrene butadiene rubber, polyvinylidene fluoride (PVDF), polyvinylidene chloride (PVDC), polyethylene oxide (PEO), polypropylene oxide (PPO), and a polyethylene oxide-propylene oxide copolymer (PEO-PPO).

[Slurry Coating Step]

As the slurry coating step, a known method can be applied. Examples thereof include methods such as roller coating such as applicator roll, screen coating, blade coating, spin coating, and bar coating.

Note that, in the positive electrode material of the solid-state battery according to the present invention, the positive electrode layer may be formed on at least one side of the current collector, and may be formed on both sides of the current collector. It can be appropriately selected depending on the type and the structure of the intended solid-state battery. Note that, after coating the current collector with the slurry, there may be steps such as drying and rolling.

It is also desired to be able to easily evaluate the positive electrode material in the method for manufacturing a positive electrode material. Therefore, it is preferable to mix with the dispersion medium after each step and evaluate the stable state of the particles. That is, after the first mixing step and before the third mixing step, a predetermined amount of the first powder is mixed with a dispersion medium and quality evaluation is performed. After the second mixing step and before the third mixing step, a predetermined amount of the second powder is mixed with a dispersion medium and quality evaluation is performed. After the third mixing step and before the slurry generating step, a predetermined amount of the third powder is mixed with a dispersion medium and quality evaluation is performed. The predetermined amount is a small amount with respect to the total amount generated, and is an amount sufficient for quality evaluation. Regarding the quality evaluation, for example, it is determined whether at least one of evaluation based on a relationship between a solid content and a hysteresis area (hereinafter, referred to as an HIS area) of a slurry to be described later and evaluation based on a relationship between the solid content and a viscosity of the slurry satisfies a predetermined requirement. The predetermined requirement is an acceptance criterion value and can be set as appropriate. Note that the quality evaluation method is not limited to this, and other methods may be used. By evaluating the stable state of the composite particles for each step, the quality for each process can be ensured.

[Example Related to Reduction in Amount of Dispersion Medium]

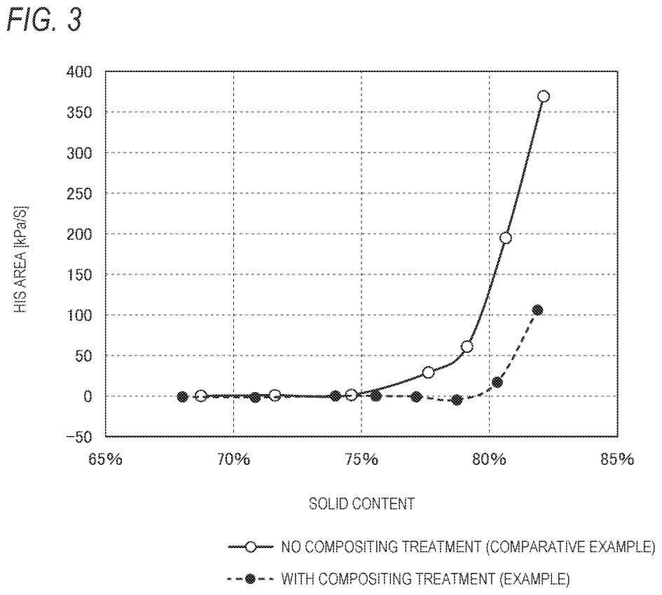

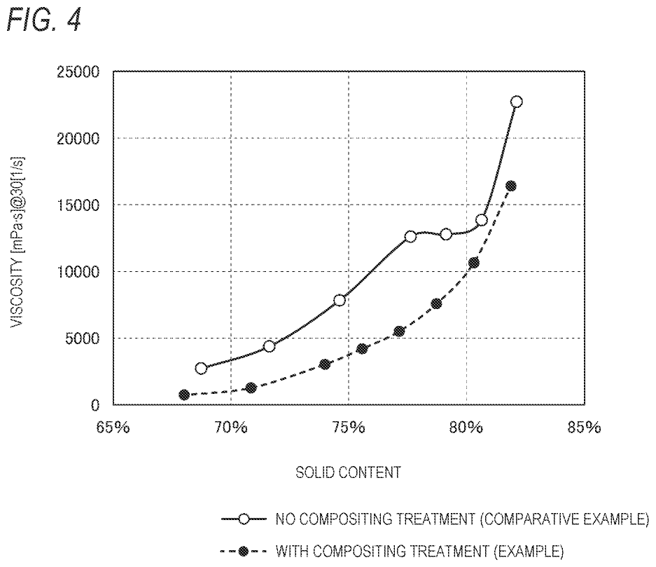

FIG. 3 is a graph showing the relationship between the solid content and the HIS area of a slurry obtained by mixing the composite particles composited by mixing in the first mixing step with a dispersion medium. FIG. 4 is a graph showing the relationship between the solid content and the viscosity of the slurry. Note that, since the viscosity of the slurry changes according to the shear rate, in the present disclosure, the viscosity means the viscosity at a shear rate of about 30 [1/s].

The solid line (with compositing treatment) in FIG. 3 and FIG. 4 concerns an Example, which is a slurry obtained by mixing, with a dispersion medium, the composite particles that have undergone the first mixing step. The dashed line (no compositing treatment) in FIG. 3 and FIG. 4 concerns an Comparative Example, which is a slurry obtained by mixing the positive electrode active material PAM and the conductive aid CA, in amounts same as those in the composite particles that have undergone the first mixing step indicated by the solid line, with a dispersion medium without compositing (without the first mixing step).

The solid content is the percentage of a solid material in the slurry (solid material+liquid material). The HIS area (hysteresis area) is an open area of a hysteresis curve (the area surrounded by the hysteresis curve) obtained from the graph showing the relationship between the shear rate (x axis) and the shear stress (y axis). The dispersed state of the solid material is seen from the HIS area (hysteresis area), and a small HIS area indicates that each material is dispersed. The viscosity is the degree of stickiness of a substance. The solvent in the dispersion medium is an unnecessary material that evaporates and flies off after coating with the slurry.

As shown in FIG. 3 and FIG. 4, the slurry containing the composite particles in Example has a smaller HIS area and a lower viscosity. From a different point of view, Table 1 shows a result of comparing the solid content when the HIS area is 2 kPa/s with the solid content when the viscosity reaches 2,700[mPa/s] at 30[1/s].

TABLE 1

| | | Comparative | Composite | Rate of |
|---|---|---|---|---|
| | | Example | particles | change |
| Comparison of | HIS area 2 kPa/s | 74.5% | 79.3% | +4.8% |
| solid content | When viscosity | 68.7% | 73.3% | +4.6% |
| | reaches 2,700 | | | |

As seen from Table 1, compared with Comparative Example, the composite particles in Example tend to have a solid content of about 5% higher when the HIS area is 2 kPa/s and when the viscosity reaches 2,700[mPa/s] at 30[1/s]. Accordingly, it can be seen that the amount of the dispersion medium for the composite particles is small.

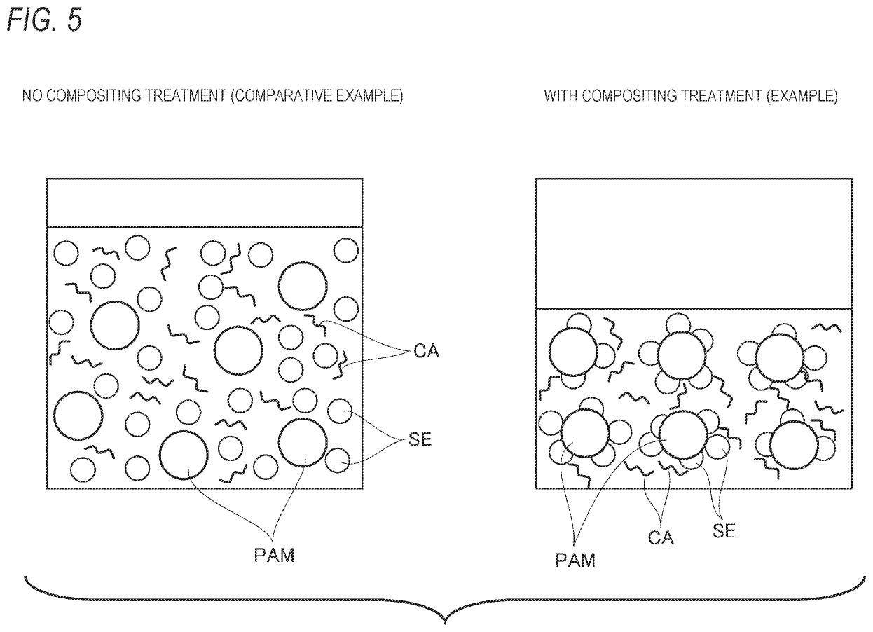

FIG. 5 is a schematic diagram showing the state of particles dispersed in a slurry in a dispersion medium. No compositing treatment (Comparative Example) is obtained by dispersing the positive electrode active material PAM, the solid electrolyte SE, and the conductive aid CA in a dispersion medium without a compositing treatment, and with compositing treatment (Example) is obtained by dispersing, in a dispersion medium, the composite particles that have undergone the first to third mixing steps and a compositing treatment.

In the slurry without a compositing treatment, since the total surface area of the particles is large, the amount of the dispersion medium is also large. On the other hand, in the composite particles with a compositing treatment, the solid electrolyte SE serving as a conduction path for lithium ions (Li⁺) is reliably in contact with the positive electrode active material PAM, and the conductive aid CA serving as an electron conduction (e⁻) path is also properly dispersed. Accordingly, since the composite particles have a small total surface area, the amount of the dispersion medium is small. In addition, since the contact area between the positive electrode active material PAM and the solid electrolyte SE is increased, the reaction resistance is decreased.

Although various embodiments are described above with reference to the drawings, it is needless to say that the present invention is not limited to such examples. It will be apparent to those skilled in the art that various changes and modifications may be conceived within the scope of the claims. It is also understood that the various changes and modifications belong to the technical scope of the present invention. Components in the embodiment described above may be combined freely within a range not departing from the spirit of the invention.

In the present description, at least the following matters are described. Note that although the corresponding constituent elements or the like in the above-described embodiments are shown in parentheses, the present invention is not limited thereto.

(1) A method for manufacturing a positive electrode material of a solid-state battery (solid-state battery 1), the method including:
a first mixing step of mixing a positive electrode active material (positive electrode active material PAM) with a conductive aid (conductive aid CA) to generate a first powder (first powder 21);
a second mixing step of mixing a solid electrolyte (solid electrolyte SE) with the conductive aid to generate a second powder (second powder 22); and
a third mixing step of mixing the first powder with the second powder to generate a third powder (third powder 23).

According to (1), when the positive electrode active material and the conductive aid are mixed in the first mixing step, the conductive aid can be wrapped around the positive electrode active material while dispersing the positive electrode active material and the conductive aid (compositing can be performed). In addition, when the solid electrolyte and the conductive aid are mixed in the second mixing step, the conductive aid can be wrapped around the solid electrolyte while dispersing the solid electrolyte and the conductive aid (compositing can be performed). Then, when the first powder and the second powder generated in the steps are mixed in the third mixing step, the conductive aid can be properly dispersed while ensuring contact between the positive electrode active material and the solid electrolyte. Accordingly, when making a slurry, the time for mixing with the dispersion medium can be greatly shortened. Further, since the surface area of the third powder can be reduced, the contact area with the dispersion medium is reduced when making slurry, and the necessary amount of the dispersion medium can be reduced.

(2) The method for manufacturing a positive electrode material according to (1), in which after the first mixing step, the first powder and a dispersion medium are mixed and quality evaluation is performed, and when a predetermined requirement is satisfied, the third mixing step is performed.

According to (2), the quality of the first powder generated in the first mixing step can be guaranteed.

(3) The method for manufacturing a positive electrode material according to (1) or (2), in which
after the second mixing step, the second powder and a dispersion medium are mixed and quality evaluation is performed, and when a predetermined requirement is satisfied, the third mixing step is performed.

According to (3), the quality of the second powder generated in the second mixing step can be guaranteed.

(4) The method for manufacturing a positive electrode material according to (2) or (3), in which
in the quality evaluation, it is determined whether at least one of evaluation based on a relationship between a solid content and a HIS area of a slurry and evaluation based on a relationship between the solid content and a viscosity of the slurry satisfies the predetermined requirement.

According to (4), the dispersed state of the particles contained in the powder can be properly determined.

(5) The method for manufacturing a positive electrode material according to any one of (1) to (4), in which
the positive electrode active material is a nickel cobalt manganese oxide,
the conductive aid is carbon, and
the solid electrolyte is a sulfide-based solid electrolyte.

(6) The method for manufacturing a positive electrode material according to any one of (1) to (5), further including:
a slurry generating step of mixing the third powder with a dispersion medium.

According to (6), a slurry can be generated with a small amount of dispersion medium.

(7) The method for manufacturing a positive electrode material according to (6), in which
after the third mixing step, the third powder and a dispersion medium are mixed and quality evaluation is performed, and when a predetermined requirement is satisfied, the slurry generating step is performed.

According to (7), the quality of the third powder generated in the third mixing step can be guaranteed.

(8) The method for manufacturing a positive electrode material according to (6) or (7), in which
the dispersion medium is butyl butyrate.

What is claimed is:

1. A method for manufacturing a positive electrode material of a solid-state battery, the method comprising:
first mixing to mix a positive electrode active material with a conductive aid to generate a first powder;
second mixing to mix a solid electrolyte with the conductive aid to generate a second powder; and
third mixing to mix the first powder with the second powder to generate a third powder.

2. The method according to claim 1, wherein
after the first mixing, the first powder and a dispersion medium are mixed and quality evaluation is performed, and when a predetermined requirement is satisfied, the third mixing is performed.

3. The method according to claim 1, wherein
after the second mixing, the second powder and a dispersion medium are mixed and quality evaluation is performed, and when a predetermined requirement is satisfied, the third mixing is performed.

4. The method according to claim 2, wherein
in the quality evaluation, it is determined whether at least one of evaluation based on a relationship between a solid content and a HIS area of a slurry and evaluation based on a relationship between the solid content and a viscosity of the slurry satisfies the predetermined requirement.

5. The method according to claim 1, wherein
the positive electrode active material is a nickel cobalt manganese oxide,
the conductive aid is carbon, and
the solid electrolyte is a sulfide-based solid electrolyte.

6. The method according to claim 1, further comprising:
a slurry generating to mix the third powder with a dispersion medium.

7. The method according to claim 6, wherein
after the third mixing, the third powder and a dispersion medium are mixed and quality evaluation is performed, and when a predetermined requirement is satisfied, the slurry generating is performed.

8. The method according to claim 6, wherein
the dispersion medium is butyl butyrate.
